(19) United States
(12) Patent Application Publication
(10) Pub. No.: US 2007/0203265 A1
(43) Pub. Date: Aug. 30, 2007

(54) Road repair material and methods

(75) Inventor: Bart Pharr, Mount Airy, NC (US)

Correspondence Address: HITT GAINES P.C., P.O. BOX 832570, RICHARDSON, TX, 75083, US

(73) Assignee: Marketing Associates, Inc., Mount Airy, NC (US)

(21) Appl. No.: 11/363,224

(22) Filed: Feb. 27, 2006

(51) Int. Cl. C04B 24/26

(52) U.S. Cl. 524/2

(57) ABSTRACT

The present invention relates to a composition for the repair of damaged load bearing surfaces such as highways, runways, taxiways, parking lots and other asphaltic or concrete load bearing surfaces; a method of preparing such compositions and methods for the use of such compositions in repairing such load bearing surfaces. The composition of the present invention utilized reclaimed surfacing materials and reclaimed rubbers in combination with virgin rubbers, resin binders and extender oils.

### TECHNICAL FIELD OF THE INVENTION

The present invention relates to a composition for the repair of damaged load bearing surfaces such as highways, runways, taxiways, parking lots and other asphaltic or concrete load bearing surfaces; a method of preparing such compositions and methods for the use of such compositions in repairing such load bearing surfaces. The composition of the present invention utilizes reclaimed surfacing materials and reclaimed rubbers in combination with virgin rubbers, resin binders and extender oils.

### BACKGROUND OF THE INVENTION

The use of reclaimed asphalt and/or concrete has been disclosed in a number of prior art patents such as for example, U.S. Pat. No. 5,223,032 to M. M. Gaudio, et al; U.S. Pat. No. 5,405,440 to H. C. Green, et al and U.S. Pat. No. 5,303,999 to R. H. Nath, et al. In such patents, particularly U.S. Pat. No. 5,223,032, asphalt pavement in a reclaimed particulated form is disclosed in combination with other asphalts which may be a virgin asphalt or a particulated recycled asphalt roofing material, a solvent such as a water base emulsion such as that known by the trade name “Reclaimite” from Witco Oil Company or an oil base solvent such as No. 4 fuel oil available from Torco Oil Company or other oil base solvents and particularly, U.S. Pat. No. 5,405,440 disclosing a reclaimed asphalt-aggregate mixture in combination with an asphalt emulsion, the asphalt emulsion consisting of bitumen along with an emulsifying agent and which may also include a rubber based polymer such as one identified as “STYRELF” and additionally, apparatus for treating recycled asphalt pavements (U.S. Pat. No. 5,303,999) or recycled asphalt for producing a hot mix pavement (U.S. Pat. No. 5,405,440).

In like manner, the use of recycled or reclaimed tire rubber is disclosed in other U.S. patents such as for example, U.S. Pat. No. 3,891,585 to C. H. McDonald; U.S. Pat. No. 5,436,285 to D. Causyn et al; U.S. Pat. No. 6,248,396 B1 to G. Helf; U.S. Pat. No. 6,706,787 B1 to M. V. Burris et al; U.S. Pat. No. 5,460,649 to D. R. Strassman; and U.S. 5,385,401 to R. H. Nath and likely others. The recycled rubbers are disclosed in combination with various asphaltic materials including recycled asphalt (U.S. Pat. No. 5,460,649; U.S. Pat. No. 5,385,401, oils such as aromatic oils, emulsifiers, fibers and other such materials.

The asphaltic/rubber containing compositions referred to the previous paragraph above, represent many different departures from simple asphalt/rubber paving and road repair compositions. Many are directed to the solving of particular surfacing or surface repair compositions, and include methods and apparatus for producing the compositions and for applying the compositions. The sheer number of prior art patents, the disclosure of asphalt/rubber compositions, methods of preparing and using such compositions and disclosing overlapping and similar components, well illustrates the very large number of different compositions, methods and apparatus which may be proposed and utilized having in common, the inclusion of asphalt and rubber along with various other components. However despite all of such prior art disclosure, there are still many possible combinations of components to form an asphalt/rubber composition including various other materials, which are novel and have various advantages including low cost and which are particularly suited for road repair applications. Additionally, as will be further discussed below in relation to the present invention, by the use of as much recycled or reclaimed asphalt and/or concrete waste materials and recycled rubber as possible, not only is lower cost and efficiency obtained but also, a significant environmental benefit results from removing such otherwise waste asphalt and/or concrete materials and waste rubber, from the environment while utilizing such waste materials beneficially.

### SUMMARY OF THE INVENTION

To address the above-discussed deficiencies, the present invention comprises a novel composition primarily for the repair of highway surfaces though such composition may be used for the repair of virtually any other load bearing surface such as runways, taxiways, parking lots, pathways and the like, and the method of manufacturing and using such novel compositions. The composition of the present invention is used to repair existing damaged load bearing surfaces containing cracks, crevasses and holes.

In accordance with the invention disclosed herein, the present invention comprises in one embodiment, a composition in turn comprises both a reclaimed asphalt and/or concrete, and a reclaimed rubber, and further includes a virgin rubber, an extender oil and a resin. This composition can be dry mixed and generally will be bagged for ready transportation in a cold state, to the location of the damaged surfaces though it can be prepared on site where it is to be applied. “Reclaimed” in reference to the asphaltic material and the rubber component, is used herein synonymously with “recycled.” The reclaimed asphalt and/or concrete if not so used in compositions such as that which is the subject of the present invention or for other beneficial use, may become an environmental problem and at best, becomes a problem in regard to its disposition. In like manner, if the rubber of automobile tires is not reclaimed and used beneficially, it also may become an environmental problem especially if such materials burn as happens frequently and additionally, in any event can become a significant problem as to disposition.

In addition to the components referred to in the previous paragraph, the compositions of the present invention may advantageously contain other materials such as fibers, fillers, and the like. Also, advantageously, when applied to repair of load bearing surfaces, the composition may be topped with a small graded aggregate which has been graded to a particular range as discussed below.

The foregoing has outlined features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiments set forth herein as a basis for designing or modifying other elements for carrying out the same purposes of the present invention. Those skilled in the art should also realize that such equivalent compositions do not depart from the spirit and scope of the present invention.

### DETAILED DESCRIPTION

Referring initially to the reclaimed waste surfacing material used in the composition of the present invention, such material may be either a reclaimed asphalt, reclaimed concrete or a combination of the two. However, reclaimed asphalt is the preferred reclaimed surface material for use in the present composition. When a reclaimed asphalt is used in the present composition, it may be one reclaimed from a asphaltic load bearing surface such as a highway, from asphalt shingles or other asphalt containing materials having a relatively high asphalt content. In the event reclaimed concrete is used instead of reclaimed asphalt, either alone or is used in combination with reclaimed asphalt, the reclaimed concrete may be obtained from the waste created from the break-up of virtually any concrete source such as highways or other loading bearing surfaces, concrete structures and the like. In obtaining reclaimed asphalt or concrete from a waste material containing such, as a practical and obvious consideration will be the asphalt or concrete content of the waste material. The higher the content of such asphalt or concrete, in most cases, the more economical will be the compositions of the present invention.

Whether reclaimed asphalt and/or reclaimed concrete is used, the initial material must be subjected to grinding and/or crushing in order to pulverize the reclaimed materials to arrive at a suitable particle size for inclusion in the present composition. Such materials are best treated to remove impurities such as particularly and primarily, dirt including that adhered to the waste asphalt or concrete, or sand or such fillers as may have been incorporated in the original surfacing material. The presence of dirt or other such impurities in the present composition may, as an example, result in inadequate bonding between components of the present invention and/or between the composition of the present invention and the load bearing surface to which the composition is applied as a repair material. Impurities such as dirt may be removed by any means known to the art including the use of vibrating screens, washing of the materials reclaimed from the breaking up or pulverizing, of an reclaimed asphalt or concrete waste material, grinding and separating by screening, high pressure vacuuming, and the like. In breaking up or pulverizing the reclaimed asphalt or concrete, it is pulverized to a size such that it may be separated by screening or otherwise to obtain the generally used particle size which for purposes of the present invention, is within the range of 1 to 20 millimeters, preferably 1 to 6 millimeters.

The amount of the reclaimed asphalt or reclaimed concrete, or combination thereof, utilized in the composition of the present invention, may be within the range of 10 to 90 weight percent of the total weight of the final composition. In referring to “final composition”, such composition is that containing the minimum ingredients as defined herein, that being the reclaimed asphalt and/or reclaimed concrete, the reclaimed rubber, the virgin rubber, the extender oil and the resin, and does not include unless otherwise specified, other materials as may additionally be added such as fillers, fibers, aggregates and the like. The preferred amount of the reclaimed asphalt and/or reclaimed concrete is no less than 10 weight percent of the final composition and no more than 90 weight percent. In the event a mixture of reclaimed asphalt and reclaimed concrete is used, it is preferred that the reclaimed asphalt comprise the larger amount of the mixed materials, generally in excess of 75 weight percent of said mixture. However, in the preferred mode of practicing the present invention, the reclaimed asphalt will represent 100% of the reclaimed load bearing surface material.

The reclaimed rubber component of the composition of the present invention is one recovered from discarded automobile tires or from other scrap rubber source. Preferably, the reclaimed rubber is that reclaimed from discarded automobile tires in order to realize the maximum environmental benefit and to obtain the optimum cost savings. In using discarded automobile tires, such material is subjected to treatment to remove any belting material such as steel and/or fibrous reinforcing materials or other non-rubber materials. This treatment may be by any of the known conventional means such as magnetic forces. Advantageously, in the present invention, the resulting reclaimed rubber is ground to produce rubber particles of between 0.1 to 5.0 millimeters in size and preferably to a size within the range of approximately 0.1 to 0.5 millimeters. These reclaimed rubber particles are then used in the composition of the present invention in an amount of at least 5 weight percent of the final composition but may be used in amounts up to 10 weight percent. Preferably, the amount of reclaimed rubber will be present in the final composition in an amount of 5 to 7 weight percent. Within the above disclosed amounts of reclaimed asphalt and reclaimed tire rubber used in the composition of the present invention, the relative amounts in relation to one another, generally will be such as to produce a weight ratio of 16 to 1 to 20 to 1, reclaimed asphalt to reclaimed tire rubber with a weight ratio of 16 to 1 being preferred.

In addition to the reclaimed rubber, a virgin rubber material, is used in the present composition. Such virgin rubber may include virtually any non-reclaimed rubber material, such as synthetic rubbers or natural rubbers. However, the virgin rubber is generally one of the synthetic rubbers that are asphalt soluble to the extent of about 2 to 12 weight percent. Such synthetic rubbers additionally are soluble with the hydrocarbon oils herein disclosed and discussed. The synthetic rubbers that can advantageously be employed are butadiene rubbers, polybutadiene polymers, butadiene-styrene polymers, styrene-butadiene-styrene copolymers and block copolymers, isoprene polymers, ethylene propylene rubbers such as GPM and EPD, ethylene propylene copolymers and terpolymers. Of these, the preferred synthetic rubbers are the butadiene-styrene copolymers, the styrene-butadiene-styrene copolymers and block copolymers, and isoprene copolymers. The most preferred of the synthetic rubbers utilized for the composition of the present invention from a cost standpoint, are the styrene-butadiene-styrene block copolymers (SBS). Of such SBS rubbers, it is preferred that the SBS polymer be one having a styrene content within the range of 25% to 30% by weight of the SBS copolymer. Examples of such preferred SBS materials, are those having the brand name Kraton D1118KG and Kraton D1164KG, which are marketed by Kraton Polymers. These synthetic polymers generally are present in the amount of 0.5 to 10 percent by weight of the final composition but preferably, within the range of 1 to 4% by weight.

As noted above, the present composition includes an extender oil which generally will be an aliphatic or napthenic oil. The purpose of such extender oil in accordance with the present invention, is to soften and improve the flexibility of the reclaimed asphaltic component and to plasticize the rubber and resin constituents of such composition. Examples of such extender oils are those having the trade names Calsol 875 manufactured by Calumet Lubricants Company, Tufflo marketed by Citgo Petroleum Corporation, and Edelex 256 from Shell Chemical Company. Such extender oils generally have such properties as a flash point as determined by ASTM 092, within the range of 280 and 500° F. but more preferably, within the range of 390 to 480° F. Such extender oils are preferably napthenic oils of molecular weight of 350 to 450. The amount of extender oil utilized generally will be within the range of 1 to 7 percent by weight of the final composition, preferably within the range of 3 to 5 percent by weight.

The resin constituent of the composition of the present invention may be a natural resin or a synthetic hydrocarbon based resin. In referring herein to natural resins, the term rosin for purposes of the present description, is included within the term “natural resins”. Such natural resins generally are obtained from pine trees or other coniferous trees and shrubs, and include such resins that have been modified such as particularly, certain rosin esters. Such natural resins have Ring and Ball softening points within the range of 50 to 200° C. but more preferred, within the range of 90 to 170° C., the optimum softening point often being determined by the ambient temperatures of the location in which the composition of the present invention is to be applied. For example, if the composition is to be applied in moderate climates, the optimum softening point would likely be within the range of 80 to 110° C. while if to be applied in areas such as the desert Southwest in summer conditions, the optimum softening point may be within the range of 140 to 200° C. Examples of suitable resins for use in the present invention are rosin esters marketed under the trademarks Sylvatac® RE100 by Arizona Chemical Company, Resinall R610 and Resinall PG12-146, both of these latter two materials marketed by Resinall Corporation. The preferred resin for use in the compositions of the present invention is an ester of a natural resin. However, in selecting the resin in relation to the environment of its use, is well within the skill of the art and upon application of the above teachings.

The hydrocarbon resins which may be used in the compositions of the present invention, are among those referred to as synthetic resins. Such synthetic resins are synthetically manufactured polymers including particularly those that are styrene based in composition having molecular weights normally well below those of the styrenic polymers known as plastics. These synthetic resins generally are preferred due to broaden compatibility with the oils of the present composition and as a practical consideration are less expensive. Such synthetic resins normally have Ring and Ball softening points within the ranges set forth above in relation to the natural resins, that is within the range of 50 to 200° C. but more preferred, 90 to 170° C. Considerations for determining a resin of optimum softening point for a particular composition within the scope of the present invention, are basically the same as discussed above in relation to the natural resins in relation to location of use and/or application of the compositions. Examples of hydrocarbon resins which may be advantageously employed in the composition of the present invention are ones marketed under the trademark Sylvares® SA 140, by Arizona Chemical Company, which is a copolymer of styrene and alpha methyl styrene having a Ring and Ball softening point of 133 to 143° C., and Escorez® marketed by ExxonMobil Chemical Company which is an aliphatic hydrocarbon resin with a low level of unsaturation and having a Ring and Ball softening point of 90 to 100° C.

The resin used in the composition of the present invention, whether such may be a natural resin or a synthetic resin, generally will be employed in the amount of 6 to 15 weight percent of the final composition but more preferably, in the amount of 7 to 10 weight percent.

The compositions of the present invention are prepared as a dry mix. The preferred method of preparing such dry mix is by bringing together the reclaimed asphalt and/or concrete component, the reclaimed rubber component, the virgin rubber component, the extender oil component, and the resin component. Advantageously, a virgin rubber and extender oil including a small part of the reclaimed rubber or only virgin rubber and extender oil, are blended together as a preblend, in a vessel separate from the other components. The resulting rubber/extender oil preblend is then mixed with the reclaimed components, i.e. the reclaimed asphalt and reclaimed rubber, and the resin. The dry mix components are then thoroughly mixed by any method of agitation available which will insure a uniform dispersion of each of the components throughout the resulting mixture. A preferred method is by utilizing a rotary blending mixing unit which is marketed by Doyle Manufacturing Inc. The preferred unit for heating the composition and applying the composition in accordance with the present invention is marketed under the trade name VIPER and marketed by H. B. Industries and is the subject matter of U.S. Pat. No. 6,012,870 to H. W. Dillingham. The mixing is carried out at elevated temperatures normally being temperatures within the range of from 125 up to 275° C., preferably having an upper limit of 220° C. The actual optimum temperatures are usually dictated by the softening points of the various components such as particularly, the reclaimed asphalt and reclaimed rubber and the resin and the location in which the composition is to be used as above discussed. The temperature used should be that which will allow the components to be thoroughly mixed together to obtain a uniform dispersion as referred to above, and to provide for the components to be bound together and for such mixture to be a solid mass of uniformly components upon the cooling of the mixture.

The solid dry mass of the composition of the present invention resulting from the method of preparing such composition as described above, is then prior to any heating, packaged into a desirable and suitable container which may include bags, barrels, pails, boxes or the like. In a preferred embodiment of the present invention, the composition is packaged in meltable bags which will melt under the conditions of softening the composition for use in repairing damaged load bearing surfaces as hereinafter discussed.

In applying the repair compositions of the present invention, the damaged area to which the present composition is to be applied, is preferably cleaned of dirt and organic matter in order to allow for optimum bonding of the repair composition of the present invention, to what will be the surfaces of the material comprising the load bearing surface being repaired and which surfaces will be in contact with the repair composition. The composition of the present invention is then heated to the extent necessary to allow it to be worked into the damaged area being repaired. Frequently, when the repair composition is in place in the damaged area and while still slightly soft, a small graded aggregate is applied across the upper surface of the composition and lightly rolled to be therein adhered. Such aggregate may be any of those known for application to load bearing surfaces for providing skid resistance. Preferably, such graded aggregate will be one graded to a particle size of 0.1 to 12 millimeters, preferably 1 to 3 millimeters.

As noted above, other materials may be added to the road repair composition of the present invention, as may be desired to improve certain characteristics of the composition. Such other materials may include any of those known for use in modifying certain properties or characteristics of an asphalt based road repair composition such as fibers, pigments, fibers vulcanizers, devulcanizers, and the like. In fact, in a preferred embodiment of the present invention, fibers are added for reinforcing and bonding of the composition and in turn, for improving resistance to cracking of the road repair composition after it is applied to the damaged area. When using the fibers as part of the composition, such fibers generally are employed in the amount of 0.01 to 1.00 weight percent of the final composition referred to above plus such fibers. Preferably, however, the amount of such fibers will be within the range of 0.04 to 0.40 weight percent of the final composition including such fibers. Fibers which may be used usually are non-woven though such may be woven. Such fibers generally may be polymeric such as fibers of polyesters, isotactic polypropylene, polyamides, polyacrylonitriles, cellulose acetate, polyvinyl chloride or polyvinyldene chlorides, or the like, or the fibers may be glass fibers such as those resulting from the chopping of glass strands, into desired lengths. A particularly desired length for the fibers is within the range of 20 to 200 millimeters. However, lengths of 30 to 70 millimeters are preferable. Generally, it is preferred that the fibers used be, the glass fibers.

In adding such materials as the fibers or other additives or modifiers, such are generally added to the composition during a mixing operation in order to obtain a good dispersion of the additive or modifying materials in the composition. When adding fibers as discussed above, such fibers are first mixed with the above described reclaimed asphalt/reclaimed rubber mixture prior to its being mixed with the preblend defined above. The fiber is then, along with the other components, thoroughly dispersed throughout the resulting mass of the composition.

In order to illustrate the present invention, a composition was prepared as follows: A preblend was prepared consisting of 2.8 weight percent of a napthenic oil having a flash point of 400° F. and a viscosity at 40° C. of 147 centistokes, and marketed by Calumet Lubricants Company as CALSOL 875, and 2.5 weight percent of a mixture of two styrene butadiene styrene copolymers, these copolymers being marketed by Kraton Polymers as Kraton D1118KG and Kraton D1164KG, in a weight ratio of 1.0:1.5. The preblend was prepared by dispersing the napthenic oil within the copolymer mixture. Once the preblend was completed, to it was added to a mixture of reclaimed asphalt milled to 1 to 6 mm, in an amount of 85.68 weight percent, a natural resin marketed by Resinall Corporation as Resinall R610 in the amount of 7.0 percent by weight, and reclaimed tire rubber ground to a size of 600 micrometers or a mesh size of 30 mesh USA standard sieve, in the amount of 2.00 percent by weight. Additionally, fiberglass in 12 mm lengths was added in an amount of 0.02 percent by weight. All weights of ingredients in this composition are based upon the total weight of the final composition including the fibers.

In the preparation of the composition, the reclaimed asphalt and reclaimed tire rubber along with the natural resin and the fiberglass were first introduced into a Viper mixing machine as above described. The preblend of the napthenic oil and the mixture of virgin rubbers after thoroughly blending in a separate container, was added to the mixture in a rotary blending machine of the type referred to herein above, and the entire mixture mixed to a uniform consistency in the rotary blending machine. After achieving the desired uniform consistency, the composition is dispensed through a discharge chute directly into a meltable bag for storage and for later transport to the damaged area to be repaired.

To apply the prepared composition of the present invention, the packaged composition is introduced into a Viper mixing unit as above referenced, and heated to a temperature within the range of 350 to 400° F. and mixed for a period of at least 30 minutes after reaching a minimum temperature of 350° F. The mixed and heated composition of the present invention is then discharged into the crack, crevice or hole of the damaged area of the load bearing structure being repaired until such crack, crevice or hole has been filled. The interior surfaces of the cracks, crevices or holes are cleaned and dried prior to the discharge of the present composition into such in order to facilitate adherence of the composition to such surfaces.

After completion of the discharge of the present composition into the cracks, crevices or holes of the load bearing surface until filed, heated metal irons are used to smooth the surface of the composition into a level construction of the surface of the load bearing structure. To the leveled surface of the composition is then applied a heated aggregate as descried above, in order to provide a skid resistant surface to the present composition. The present composition is then allowed to cool and upon cooling to approximately 100° F., the surface of the composition is ready to receive loads commensurate with those which the surrounding load bearing structure, is structured to receive.

In other embodiments of the present invention, the repair composition of the present invention may be used without the fiber or other such materials intended to enhance bonding and/or to provide greater resistance to future cracking or break-up of the composition after it has set into the damaged area. Additionally, the use of the aggregate as a final step in utilizing the repair composition of the present invention will depend upon whether the surface of the load bearing structure being repaired, is one having anti-skid properties.

Although the present invention has been described in detail, those skilled in the art should understand that they can make various changes, substitutions and alterations herein without departing from the spirit and scope of the invention in its broadest form.

What is claimed is:

1. A composition for the repair of damaged load bearing surfaces comprising in combination, (a) a reclaimed load bearing surface material selected from asphalt, concrete and combinations of asphalt and concrete, (b) a reclaimed rubber material, (c) a virgin rubber, (d) a resinous binder selected from natural resins and hydrocarboncious resins, and (e) an extender oil.

2. The composition of claim 1 wherein the reclaimed load bearing surface material is reclaimed asphalt.

3. The composition of claim 2 wherein the reclaimed asphalt is present in the final composition in the amount of 10 to 90 weight percent.

4. The composition of claim 1 wherein the reclaimed tire rubber is present in the final composition in an amount of 5 to 10 weight percent.

5. The composition of claim 1 wherein the virgin rubber is a synthetic rubber that is asphalt soluble to the extent of about 2 to 12 weight percent.

6. The composition of claim 5 wherein the virgin rubber is one selected from the group consisting of butadiene polymers, polybutadiene polymers, butadiene-styrene copolymers, styrene-butadiene-styrene copolymers and block copolymers, isoprene polymers, ethylene propylene rubbers, and ethylene propylene copolymers and terpolymers.

7. The composition of claim 6 wherein the virgin rubber is a styrene-butadiene-styrene block copolymer having a styrene content within the range of 25 to 30 percent by weight of the copolymer.

8. The composition of claim 1 wherein the resinous binder is a natural resin.

9. The composition of claim 1 wherein the resinous material is a hydrocarbonacious resin.

10. The composition of claim 1 wherein the resinous binder is present in the amount of 6 to 15 weight percent of the final composition.

11. The composition of claim 1 wherein the flash point of the extender oil is within the range of 280 and 500° F.

12. The composition of claim 1 wherein the extender oil is one selected from the group consisting of aliphatic or napthenic oils.

13. The composition of claim 12 wherein the extender oil is present in the final composition in an amount of 1 to 7 percent by weight.

14. The composition of claim 1 wherein a fiber is included in the amount of 0.01 to 1.0 weight percent of the total weight of the composition of claim 1 plus such fiber.

15. The composition of claim 14 wherein the fiber is a glass fiber with the fibers having a length within the range of 20 to 200 millimeters.

16. A method of preparing a composition for the repair of damaged load bearing surfaces comprising:
the mixing together to an uniform consistency of;
(a) a reclaimed load bearing surface material selected from asphalt, concrete and asphalt/concrete combinations;
(b) a reclaimed tire rubber;
(c) a virgin rubber;
(d) a resinous binder selected from the group consisting of natural resins and hydrocarbonacious resins; and
(e) an extender oil.

17. The composition of claim 16 wherein the mixing is accomplished by preparing a pre-blend comprising (a) an extender oil selected from the group consisting of napthenic oils and aliphatic oils, and (b) a virgin rubber and separately, (c) a mixture of reclaimed load bearing surface materials selected from the group consisting of asphalt, concrete and asphalt/concrete mixtures, (d) a natural resin, and (e) reclaimed tire rubber, and then mixing together the pre-blend with said mixture under mixing conditions such as to create a uniform mixture in which the various constituents are uniformly dispersed throughout said resulting mixture.

18. A method of repairing damaged areas of load bearing surfaces such method comprising of introducing into a crevice in a load bearing surface, the composition of claim 1 under moldable conditions of above ambient temperature, smoothing the upper surface of such composition to the level of the surface of the surrounding load bearing surface, introducing across the top of the upper surface of said composition, a graded aggregate to impact resistance to such surface against sliding on such surface of wheels of load bearing vehicles traversing across such surface, applying pressure to the aggregate surface such as to crevice such aggregate to be adhered to said composition, allowing such composition to cool to ambient temperatures.

19. The method of claim 18 wherein the aggregate is one that has been graded to a size of between 0.1 to 12 mm.
